(19) United States
(12) Patent Application Publication
(10) Pub. No.: US 2025/0007847 A1
(43) Pub. Date: Jan. 2, 2025

(54) AUTOMATICALLY PROVISIONING LOW LATENCY SERVICES IN CABLE TELEVISION (CATV) NETWORKS COMPLIANT WITH LOW LATENCY DOCSIS (LLD)

(71) Applicant: ARRIS Enterprises LLC, Horsham, PA (US)

(72) Inventors: Aniket A. SALUNKHE, Thane (IN); Rajat GHOSH, Bangaluru (IN)

(73) Assignee: ARRIS Enterprises LLC, Horsham, PA (US)

(21) Appl. No.: 18/759,337

(22) Filed: Jun. 28, 2024

Related U.S. Application Data
(60) Provisional application No. 63/523,781, filed on Jun. 28, 2023.

(51) Int. Cl. H04L 47/2408; H04L 12/28; H04L 47/2475; H04L 69/22

(52) U.S. Cl. CPC H04L 47/2408; H04L 12/2801; H04L 47/2475; H04L 69/22

(57) ABSTRACT

Devices, systems, and methods that automate the configuration of the low latency services with their dynamically changing attributes on the subscriber managed devices. The devices, systems, and methods may include receiving a plurality of data packets associated with the application, each data packet including a header portion and a payload portion. The payload portions of the data packets are analysed and the analysis of the payload portions is used to selectively classify a subset of the analyzed packets as being associated with low latency service.

### CROSS REFERENCE TO RELATED APPLICATIONS

The present application claims priority to U.S. Provisional Application No. 63/523,781 filed Jun. 28, 2024, the content of which is incorporated herein by reference in its entirety.

### TECHNICAL FIELD

The present disclosure in general relates to techniques of provisioning low-latency service flow. More precisely, the present disclosure relates to provisioning low-latency service flow in a cable television (CATV) communication network conforming to Data Over Cable Service Interface Specification (DOCSIS) standard.

### BACKGROUND

Cable Television (CATV) services have historically provided content to large groups of subscribers from a central delivery unit, called a “head end,” which distributes channels of content to its subscribers from this central unit through a branch network comprising a multitude of intermediate nodes. Historically, the head end would receive a plurality of independent programming content, multiplex that content together while simultaneously modulating it according to a Quadrature Amplitude Modulation (QAM) scheme that maps the content to individual frequencies or “channels” to which a receiver may tune so as to demodulate and display desired content.

Modern CATV service networks, however, not only provide media content such as television channels and music channels to a customer, but also provide a host of digital communication services such as Internet Service, Video-on-Demand, telephone service such as VoIP, and so forth. These digital communication services, in turn, require not only communication in a downstream direction from the head end, through the intermediate nodes and to a subscriber, but also require communication in an upstream direction from a subscriber, and to the content provider through the branch network.

To this end, these CATV head ends include a separate Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company's hybrid fiber coax (HFC) system. Downstream traffic is delivered from the CMTS to a cable modem in a subscriber's home, while upstream traffic is delivered from a cable modem in a subscriber's home back to the CMTS. Many modern CATV systems have combined the functionality of the CMTS with the video delivery system (Edge QAM) in a single platform called the Converged Cable Access Platform (CCAP). The foregoing architectures are typically referred to as centralized access architectures (CAA) because all of the physical and control layer processing is done at a central location, e.g., a head end.

Recently, distributed access architectures (DAA) have been implemented that distribute the physical layer processing, and sometimes the MAC layer processing deep into the network. Such systems include Remote PHY (or R-PHY) architectures, which relocate the physical layer (PHY) of a traditional CCAP by pushing it to the network's fiber nodes. Thus, while the core in the CCAP performs the higher layer processing, the R-PHY device in the node converts the downstream data sent by the core from digital-to-analog to be transmitted on radio frequency as a QAM signal and converts the upstream RF data sent by cable modems from analog-to-digital format to be transmitted optically to the core. Other modern systems push other elements and functions traditionally located in a head end into the network, such as MAC layer functionality (R-MACPHY), etc.

Evolution of CATV architectures, along with the Data Over Cable Service Interface Specification (DOCSIS) standard, have typically been driven by increasing consumer demand for bandwidth, and more particularly growing demand for Internet and other data services. However, bandwidth is not the only consideration, as many applications such as video teleconferencing, gaming, etc. also require low latency. Thus, the DOCSIS 3.1 specifications incorporated the Low Latency DOCSIS (LLD) feature to enable lower latency and jitter values for latency-sensitive applications by creating two separate service flows, where latency-sensitive traffic is carried over its own service flow that is prioritized over traffic that is not latency-sensitive.

Although the DOCSIS 3.1 standard allows for bifurcation of traffic into low-latency and non-low-latency traffic, but the LLD configuration is done through a bootup file, and for Low Latency Service Flow (SF) details of applications are configured manually. The DOCSIS configuration for low latency applications/services is not dynamic. In particular, the user needs to manually configure the packet information (i.e., port numbers) of applications, so that they reach low latency SF. Accordingly, LLD Cloud VNF (a component of LLD SaaS) maintains the applications/services to the traffic selection map. Additionally, the configured parameters (i.e., port numbers and protocol type) for any application is not guaranteed to be the same over time. If the port numbers and/or protocol type are updated for the application configured with low latency, the user must manually reconfigure it.

Thus, there exists need of techniques which enable automatic configuration of an application as low latency application based on the parameters of the application.

### SUMMARY

One or more shortcomings discussed above are overcome, and additional advantages are provided by the present disclosure. Additional features and advantages are realized through the techniques of the present disclosure. Other embodiments and aspects of the disclosure are described in detail herein and are considered a part of the disclosure.

One general aspect includes a method of provisioning low-latency service flow for data packets associated with an application in a communication network conforming to data over cable service interface specification (DOCSIS) standard. The method also includes receiving a plurality of data packets associated with one or more applications, each data packet including a payload portion. The method also includes analyzing the payload portions of the data packets. The method also includes using the analysis of the payload portions to selectively classify a subset of the analyzed packets as being associated with low latency service. Other embodiments of this aspect include corresponding computer systems, apparatus, and computer programs recorded on one or more computer storage devices, each configured to perform the actions of the methods.

Implementations may include one or more of the following features. The method where the analysis of the payload portions may include comparing payload attributes of the payload portions to predetermined attributes of low latency applications. The method where the payload attributes are selected from a group may include: an application category and an application name. The method further including the steps of: using the classification of the subset of the analyzed packets to determine a set of additional attributes in the analyzed data packets; and using the additional attributes to classify additional data packets as being associated with low latency service. The method where the additional attributes are in a header of the analyzed packets, and the additional data packets are associated with low latency service by examining the header of the additional data packets. The additional attributes are selected from a group may include one or more of: an application port number, an IP protocol, an application IP address, an application IP mask, a destination IP address, a destination IP mask, an application IP port start and port end, a destination port start and port end, a destination MAC address, an application AMC address, an ethernet/DSA/MAC type, and a virtual LAN identification (VLAN ID). Implementations of the described techniques may include hardware, a method or process, or computer software on a computer-accessible medium.

One general aspect includes an apparatus for provisioning low-latency service flow for data packets associated with an application in a communication network conforming to data over cable service interface specification (DOCSIS) standard. The apparatus also includes a memory. The apparatus also includes processors communicatively coupled with the memory and configured to: receive a plurality of data packets associated with the application, each data packet including a payload portion. The processors also analyze the payload portions of the data packets; and use the analysis of the payload portions to selectively classify a subset of the analyzed packets as being associated with low latency service. Other embodiments of this aspect include corresponding computer systems, apparatus, and computer programs recorded on one or more computer storage devices, each configured to perform the actions of the methods.

Implementations may include one or more of the following features. The apparatus where the processors are configured to analyze the payload portions by comparing payload attributes of the payload portions to predetermined attributes of low latency applications. The payload attributes are selected from a group may include: an application category and an application name. The processors are further configured to: use the classification of the subset of the analyzed packets to determine a set of additional attributes in the analyzed data packets; and use the additional attributes to classify additional data packets as being associated with low latency service. The additional attributes are in a header of the analyzed packets, and the additional data packets are associated with low latency service by examining the header of the additional data packets. The additional attributes are selected from a group may include: an application port number, an IP protocol, an application IP address, an application IP mask, a destination IP address, a destination IP mask, an application IP port start and port end, a destination port start and port end, a destination MAC address, an application MAC address, an ethernet/DSA/MAC type, and a virtual LAN identification (VLAN ID). To provision the low latency service flow for data packets based on the additional attributes, processors are configured to: update access control lists (ACLs) of the communication network using secondary attributes; and transmit the additional attributes to a cable modem (CM) of the communication network for identification of the low latency traffic in the communication network. Implementations of the described techniques may include hardware, a method or process, or computer software on a computer-accessible medium.

One general aspect includes a low-latency DOCSIS (LLD) agent in operative communication with at least one edge device that propagates a signal onto a communications network. The low latency DOCSIS also includes an input that receives a first plurality of data packets eligible for low latency service over the communications network, each having a header and a payload; a processor that analyses the payload of the data packets and uses the analysis to identify header characteristics of the header of the first plurality of data packets; and an output that provides the edge device with the header characteristics, the header characteristics usable by the edge device to identify a second plurality of data packets, different from the first plurality of data packets, also eligible for low latency service over the communications network. Other embodiments of this aspect include corresponding computer systems, apparatus, and computer programs recorded on one or more computer storage devices, each configured to perform the actions of the methods.

Implementations may include one or more of the following features. The LLD agent where the analysis of the payload portions may include comparing payload attributes of the payload portions to predetermined characteristics of low latency applications. The LLD agent configurable by a cloud agent to modify the payload attributes. The LLD agent where the predetermined characteristics may include at least one of an application category and an application name. The LLD agent where the header characteristics are selected from a group may include: an application port number, an IP protocol, an application IP address, an application IP mask, a destination IP address, a destination IP mask, an application IP port start and port end, a destination port start and port end, a destination mac address, an application mac address, an Ethernet/DSA/MAC type, and a virtual LAN identification (VLAN ID). The LLD agent where the at least one edge device is at least one of a cable modem termination service (CMTS), a remote physical device (RPD), a remote MACPHY device (RMD) and a cable modem. Implementations of the described techniques may include hardware, a method or process, or computer software on a computer-accessible medium.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. Some embodiments of the apparatus and/or methods in accordance with embodiments of the present subject matter are now described, by way of example only, and with reference to the accompanying Figures, in which:

FIG. 1 shows an exemplary centralized access architecture (CAA) where the techniques of the present disclosure may be implemented, in accordance with some embodiments of the present disclosure;

FIG. 2 shows an exemplary distributed access architecture (DAA) where the techniques of the present disclosure may be implemented, in accordance with some embodiments of the present disclosure;

FIG. 3A shows an exemplary high level LLD service configuration indicating service flow traffic classification in accordance with some embodiments of the present disclosure;

FIG. 3B shows an exemplary upstream traffic flow through a CATV network, in accordance with some embodiments of the present disclosure;

FIG. 4A shows one exemplary architecture for configuring an application for low latency service flow in accordance with some embodiments of the present disclosure;

FIG. 4B shows a signal flow for the architecture shown in FIG. 4A for configuring an application for low latency service flow in accordance with some embodiments of the present disclosure;

FIG. 5A shows another exemplary architecture for configuring an application for low latency service flow in accordance with some embodiments of the present disclosure;

FIG. 5B shows a signal flow for the architecture shown in FIG. 5A for configuring an application for low latency service flow in accordance with some embodiments of the present disclosure;

FIG. 6 shows a high-level block diagram of an exemplary apparatus which may implement the techniques in accordance with some embodiments of the present disclosure;

FIG. 7 shows a block diagram of an LLD agent which may implement the techniques in accordance with some embodiments of the present disclosure; and

FIG. 8 depicts a flowchart illustrating an exemplary method for provisioning low-latency service flow in accordance with some embodiments of the present disclosure.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

In the context of present disclosure, a packet flow may be defined as a flow of Internet Protocol (IP) packets or data packets between an application server and a subscriber device through a specific port number or a specific port range. In the present disclosure, the terms like “packet classifier” and “LLD packet classifier” have been used interchangeably throughout the description. Further, the terms like “attributes” and “characteristics” have been used interchangeably throughout the description. Furthermore, the terms like “data packets” and “packets”, and “LLD agent” and “agent” have been used interchangeably throughout the description.

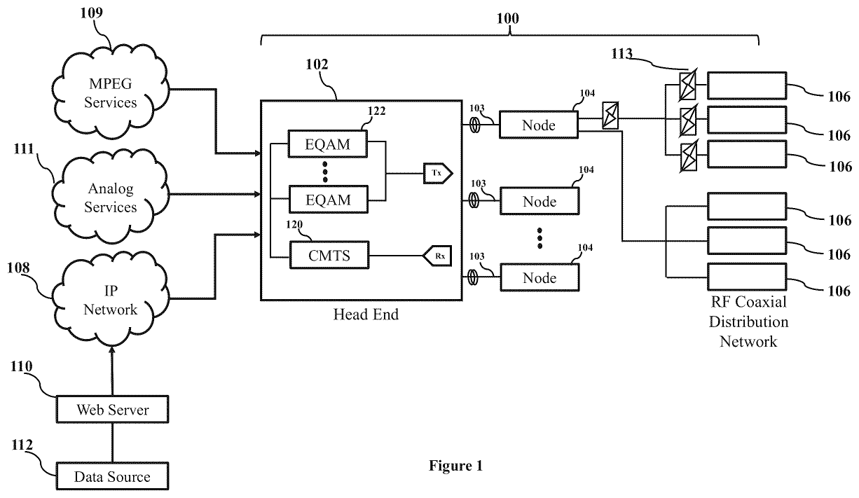

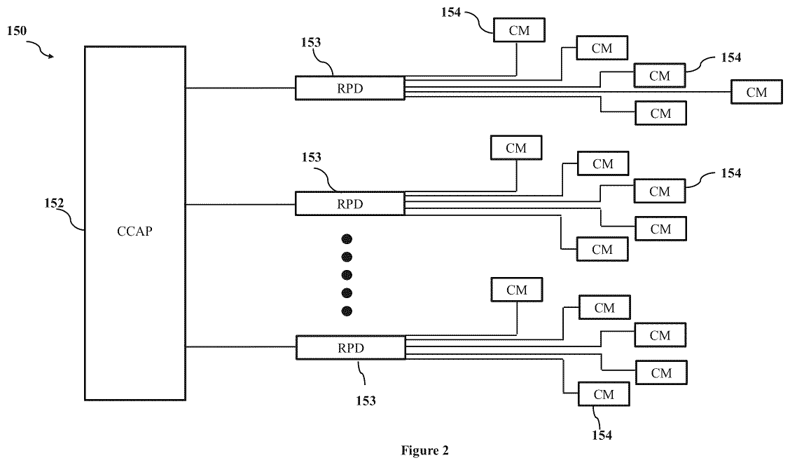

The present disclosure describes methods and apparatuses for provisioning low latency services in a Cable Television (CATV) network compliant with Low Latency Data Over Cable Service Interface Specification (DOCSIS) standard. The methods and apparatuses disclosed in the present application may be implemented with respect to a communications network that provides data services to consumers, regardless of whether the communications network is implemented as a CAA architecture or a DAA architecture, as shown respectively in FIGS. 1 and 2.

FIG. 1 shows an exemplary centralized access architecture (CAA) where the techniques of the present disclosure may be implemented. Specifically, FIG. 1 illustrates an exemplary Cable Television (CATV) network infrastructure comprising a Hybrid Fiber Coaxial (HFC) broadband network 100 that combines use of optical fiber and coaxial connections. The HFC network 100 includes a head end 102 that receives analog or digital video signals and digital bit streams representing different services (e.g., video, voice, and Internet) from various digital information sources. For example, the head end 102 may receive content from one or more video on demand (VOD) servers, Internet Protocol television (IPTV) broadcast video servers, Internet video sources, or other suitable sources for providing IP content.

As shown in FIG. 1, the CATV network infrastructure includes an IP network 108, MPEG services 109, and analog services 111. The IP network 108 may further include a web server 110 and a data source 112 comprising IP content. The web server 110 may be a streaming server that uses the IP protocol to deliver video-on-demand, audio-on-demand, and pay-per view streams to the IP network 108. The IP data source 112 may be connected to a regional area or backbone network (not shown) that transmits IP content to the IP data source 112. For example, the regional area network may be or include the Internet or an IP-based network, a computer network, a web-based network, or other suitable wired or wireless network or network system.

At the head end 102, the services described earlier are typically encoded, modulated and up-converted onto RF carriers, combined onto a single electrical signal and inserted into a broadband optical transmitter. A fiber optic network may extend from the cable operator's master/regional head end 102 to a plurality of fiber optic nodes 104 (also known as “field optical nodes”). The head end 102 may contain an optical transmitter or transceiver to provide optical communications through optical fibers 103. Regional head ends and/or neighborhood hub sites may also exist between the head end 102 and one or more nodes. The fiber optic portion of the exemplary HFC network 100 extends from the head end 102 to the regional head end/hub and/or to the plurality of fiber optic nodes 104. The optical transmitter converts the electrical signal to a downstream optically modulated signal that is sent to the fiber optic nodes 104. In turn, the fiber optic nodes 104 convert inbound signals to RF energy and return RF signals to optical signals along a return path. In the specification, the drawings, and/or the claims, the terms “forward path” and “downstream” may be interchangeably used to refer to a path from a head end to a node, a node to a subscriber, or a head end to a subscriber. Conversely, the terms “return path”, “reverse path” and “upstream” may be interchangeably used to refer to a path from a subscriber to a node, a node to a head end, or a subscriber to a head end.

Each fiber optic node 104 serves a service group comprising one or more customer locations. By way of example, a single fiber optic node 104 may be connected to thousands of cable modems or other subscriber devices 106. In an example, a fiber optic node 104 may serve few thousands or more customer locations. In an HFC network 100, the fiber optic node 104 may be connected to a plurality of subscriber devices 106 via coaxial cable cascades. Though those of ordinary skill in the art will appreciate that the coaxial cable cascade may comprise a combination of fiber optic cable and coaxial cable, in some implementations each fiber optic node 104 may include a broadband optical receiver to convert the downstream optically modulated signal received from the head end 102 or a hub to an electrical signal provided to the subscribers' devices 106 through the coaxial cable cascade. Signals may pass from the fiber optic node 104 to the subscriber devices 106 via the coaxial cable cascade which may be comprised of multiple amplifiers 113 and active or passive devices including cabling, taps, splitters, and in-line equalizers. It should be understood that the amplifiers 113 in the coaxial cable cascade may be bidirectional, and may be cascaded such that an amplifier may not only feed an amplifier further along in the cascade but may also feed a large number of subscribers. In general, a tap is a customer's drop interface to a coaxial distribution system and taps are designed in various values to allow amplitude consistency along the coaxial distribution system.

The subscriber devices 106 may reside at a customer location, such as a home of a cable subscriber, and are connected to a cable modem termination system (CMTS) 120 or comparable component located in the head end 102. A subscriber device 106 may be a modem, e.g., a Cable Modem (CM), a media terminal adaptor (MTA), a set top box, a terminal device, a television equipped with a set top box, a Data Over Cable Service Interface Specification (DOCSIS) terminal device, a customer premises equipment (CPE), a router, or similar electronic client, or terminal devices of subscribers. For example, cable modems and IP set top boxes may support data connection to the Internet and other computer networks via the HFC network 100, and the HFC network 100 provides bi-directional communication systems in which data can be sent downstream from the head end 102 to a subscriber and upstream from a subscriber to the head end 102.

References are made in the present disclosure to a Cable Modem Termination System (CMTS) 120 in the head end 102. In general, the CMTS 120 is a component located at the head end 102 or a hub site of the CATV network infrastructure that exchanges signals between the head end 102 and subscriber devices 106 within the CATV network infrastructure. In an example DOCSIS arrangement, the CMTS 120 and the cable modem may be the endpoints of the DOCSIS protocol, with a hybrid fiber coaxial (HFC) cable transmitting information between these endpoints. It will be appreciated that the HFC network 100 includes one CMTS 120 for illustrative purposes only and, in general, multiple CMTSs and their Cable Modems may be managed through the single HFC network 100.

The CMTS 120 may host downstream and upstream ports and may contain numerous receivers, each receiver handling communications between hundreds of end user network elements connected to the HFC network 100. For example, each CMTS 120 may be connected to several cable modems of many subscribers, e.g., a single CMTS may be connected to hundreds of cable modems that vary widely in communication characteristics. In many instances several nodes, such as fiber optic nodes 104, may serve a particular area of a town or city. DOCSIS enables IP data packets to pass between devices on either side of a link between the CMTS 120 and the cable modem.

It should be understood that the CMTS 120 is a non-limiting example of a component in the CATV network infrastructure that may be used to exchange signals between the head end 102 and the subscriber devices 106 within the CATV network infrastructure. For example, other non-limiting examples of components used to exchange signals between the head end 102 and the subscriber devices 106 within the CATV network infrastructure may also include a Modular CMTS (M-CMTS) architecture or a Converged Cable Access Platform (CCAP).

The head end 102 or hub device may comprise at least one Edge Quadrature Amplitude Modulators (EdgeQAM or EQAM) 122 or EQAM modulator for receiving packets of digital content, such as video or data, re-packetizing the digital content into an MPEG transport stream, and digitally modulating the transport stream onto a downstream RF carrier using Quadrature Amplitude Modulation (QAM). EQAMs 122 may be used for both digital broadcast, and DOCSIS downstream transmission. In CMTS or M-CMTS implementations, data and video QAMs may be implemented on separately managed and controlled platforms. In CCAP implementations, the CMTS and edge QAM functionality may be combined in one hardware solution, thereby combining data and video delivery.

Referring now to FIG. 2, which illustrates an exemplary distributed access architecture (DAA architecture e.g., a R-PHY architecture, although other DAA architectures may include R-MACPHY architectures, optical line terminal architectures (R-OLT architectures), etc. Specifically, a distributed CATV network architecture 150 may include a Converged Cable Access Platform (CCAP) 152 at a head end connected to a plurality of cable modems (CMs) 154 via a branched transmission network that includes a plurality of Remote PHY device (RPD) nodes 153. The RPD nodes 153 perform the physical layer processing by receiving downstream, typically digital content via a plurality of northbound ethernet ports, converting the downstream to QAM modulated signals where necessary, and propagating the content as RF signals on respective southbound ports of a coaxial network to the cable modems 154. In the upstream direction, the RPD nodes 153 receive upstream content via the southbound RF coaxial ports, convert the upstream content to optical data stream in optical domain, and transmit the optical data stream to the CCAP 152. The architecture of FIG. 2 is shown as an R-PHY system where the CMTS 120 operates as the CCAP 152 while the RPDs 153 are located downstream, but alternate systems may use a traditional CCAP operating fully in an Integrated CMTS in a head end, connected to the cable modems 154 via a plurality of nodes/amplifiers.

The techniques disclosed herein may be applied to systems and networks compliant with DOCSIS. The cable industry implements the international Data Over Cable System Interface Specification (DOCSIS®) standard or protocol to enable delivery of IP data packets over cable networks. In general, DOCSIS defines communications and operations support interface requirements for a data over cable system. For example, DOCSIS defines the interface requirements for cable modems involved in high-speed data distribution over CATV networks. However, it should be understood that the techniques disclosed herein may apply to any system for digital services transmission, such as digital video or Ethernet PON over Coax (EPoC). Examples herein referring to DOCSIS are illustrative and representative of the application of the techniques to a broad range of services carried over coax.

As noted earlier, although CATV network architectures have historically evolved in response to increasing consumer demand for bandwidth, many applications such as video teleconferencing, video streaming, online gaming, etc. also require low latency. Specifically, certain services cannot be further improved simply by adding additional bandwidth. Such services include web meetings and live video, as well as online gaming or medical applications. For these applications, latency as well as jitter (which can be thought of as variation in latency) are at least equally important as bandwidth.

For instance, in online gaming applications that involve multiple players competing and collaborating over a common server, latency has an arguably greater impact on gameplay than bandwidth. In this fast-paced environment, millisecond connection delays are the difference between success and failure. As such, low latency is a well-recognized advantage in online multiplayer games. With lower latency (i.e., the time that packets spend reaching gaming server and returning a response to the multiplayer gamer), players can literally see and do things in the game before others can. The same analysis can be applied to finance and day trading as well as other latency sensitive applications.

Thus, end-to-end latency has several contributing causes, the most obvious being propagation delay between a sender and a receiver however, many other causes of latency are at least as significant. For example, a gaming console itself introduces approximately 50 ms of latency and creating an image on-screen by a computer or console takes between 16 ms to 33 ms to reach the screen over a typical High-Definition Multimedia Interface (HDMI) connection. However, the most significant source of latency is queuing delay, typically within the networks as shown in FIG. 1 and FIG. 2. As most applications rely on Transmission Control Protocol (TCP) or similar protocols, which emphasize optimizing bandwidth, ‘congestion avoidance’ algorithms in the access networks usually adjusts to a link based on its speed. Buffers and queues on that link are stressed to the limit, which optimizes bandwidth but increases the latency.

Typically, all network traffic merges into a single DOCSIS service flow. This network traffic includes both streams i.e., streams that build queues (like video streaming applications) and streams that do not build queues (like multiplayer gaming applications). The applications that build queues (e.g., video streaming applications) may be referred to as “queue building applications” and the streams or flows associated with the queue building applications may be referred to as “classic service flows” or “classic SF” or “normal service flows”. Similarly, the applications that do not build queues (e.g., online gaming applications) may be referred to as “non-queue building applications” and the streams or flows associated with the non-queue building applications may be referred to as “low-latency service flows” or “low latency SF”. The challenge that the single-flow architecture presents is a lack of distinction between the two types of flows. Both a gaming application and a video streaming application are treated identically by traditional networks, but their needs are very different. A queueing delay might not matter for the purpose of watching a YouTube video, which can buffer and play asynchronously, but for competing in a multiplayer online game, having data packets held in a queue is a meaningful disadvantage. This indiscriminate treatment of traffic on today's DOCSIS networks adds latency and jitter precisely where it is unwanted.

To reduce the latency and jitter in the CATV networks, a new feature has been introduced in the DOCSIS called Low Latency DOCSIS (LLD). LLD architecture resolves the queueing latency by using a dual queuing approach. Applications which are not queue building (such as online gaming applications) will use a different queue than the traditional queue building applications (such as file downloads). Non-queue building traffic will use small buffers to minimize the latency and queue building traffic will use larger buffers to maximize the throughput. LLD therefore allows operators to provision low-latency services.

Specifically, the LLD architecture offers several new key features, including ASF (Aggregate Service Flow) encapsulation, which manages traffic shaping of both service flows by enforcing an Aggregate Maximum Sustained Rate (AMSR), where the AMSR is the combined total of the low-latency and classic service flow bit rates, Proactive Grant Service scheduling, which enables a faster request grant cycle by eliminating the need for a bandwidth request, as well as other innovations such as Active Queue Management algorithms which drop selective packets to maintain a target latency.

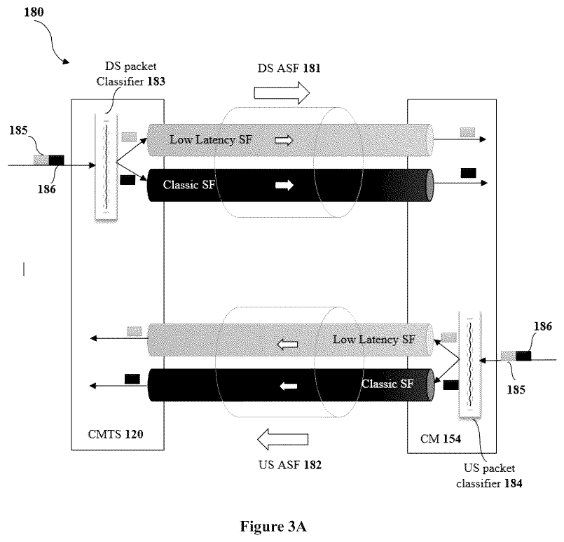

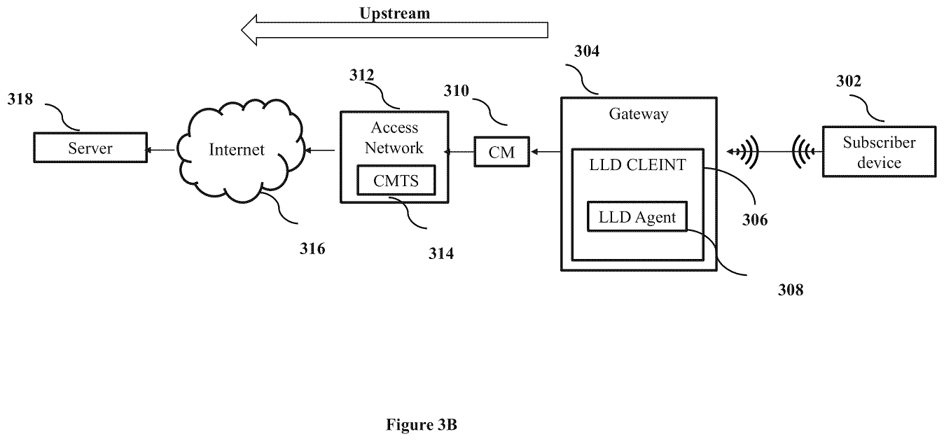

One other feature inherently necessary for LLD is service flow traffic classification i.e., classifying IP packets as belonging either to the Classic service flow of the Low-Latency service flow, as shown in FIG. 3A. Referring now to FIG. 3A, which shows a high level LLD service configuration 180 indicating service flow traffic classification, in accordance with some embodiments of the present disclosure. As shown in FIG. 3A, the LLD service configuration 180 comprises a single downstream Aggregate Service Flow (DS ASF) 181 from the CMTS 120 to the CM 154 and a single upstream Aggregate Service Flow (US ASF) 182 from the CM 154 to the CMTS 120. Each of the downstream and upstream ASF comprises two individual service flows—one service flow for low latency traffic (also known as “low latency SF”) and one service flow for classic traffic (also known as “classic SF”). The low latency SF may have a dedicated first traffic queue for handling low latency traffic and the classic SF may have a dedicated second traffic queue for handling classic service flows.

The CMTS 120 and the CM 154 may be provisioned with a plurality of LLD packet classifiers which segment the traffic of corresponding Aggregate Service Flow into the two service flows. Specifically, the CMTS 120 is provisioned with a plurality of downstream LLD packet classifiers 183 which segment the incoming traffic from an application server such that matching IP packets 185 associated with non-queue building applications are transmitted over the Low Latency SF and non-matching IP packets 186 associated with queue building applications are transmitted over the Classic SF. Similarly, the CM 154 is provisioned with a plurality of upstream LLD packet classifiers 184 which segment the outgoing traffic from a subscriber device such that matching IP packets 185 associated with non-queue building applications are transmitted over the Low Latency SF and remaining non-matching IP packets 186 associated with queue building applications are transmitted over the Classic SF. In summary, the packet classifiers 183, 184 may classify IP packets of the Low latency SF as having high priority and IP packets of the Classic SF as having normal priority.

Though packet classification and configuring classifiers in the CMTS/CM play a crucial role in implementing LLD, the DOCSIS standard is silent on how the IP packets are classified and put on the low latency service flow and how the packet classifiers are provisioned (or added) in the CMTS 120 and CM 154 for classifying and directing the IP packets to one of the low-latency SF or the Classic SF. In some implementations, the non-queue building (NQB) applications may mark packets as belonging to Low Latency SF. For instance, NQB applications such as online games may tag their IP packets with NQB Differentiated Services (DiffServ) value or support Explicit Congestion Notification (ECN) to indicate that they behave in a non-queue-building way so that one or more packet classifiers provisioned in the CMTS 120 and CM 154 (as shown in FIG. 3A) can easily classify their IP packets into the Low Latency SF. The packet classifiers may examine DiffServ Field and ECN Field, which are standard elements of the IPv4/IPv6 header. Specifically, IP packets with an NQB DiffServ value or an ECN field indicating either ECN Capable Transport or Congestion Experienced (CE) get mapped to the Low Latency SF and the rest of the IP packets are mapped to the Classic SF.

In other implementations, customer premises gateways may analyze IP packets to map selected IP packets onto the low-latency SF. Some other implementations may reliably identify IP packets in a service flow as being low latency packets, and in a manner that does not rely on specific hardware at either a subscriber device or a server (gaming server, financial server, etc.) communicating with that subscriber device. For instance, some implementations may employ a LLD agent 308, as shown in FIG. 3B, which may process the data packets to add appropriate information to the data packets by which the one or more packet classifiers provisioned in the CMTS 120, 314 and CM 154, 310 (as shown in FIG. 1 and FIG. 3B) can identify and direct the data packets to a respectively appropriate one of the low-latency SF or classic SF. The LLD agent 308 may identify the characteristics or attributes of the low-latency traffic in a number of desired manners. For example, the LLD agent 308 may store a current list of non-queue building applications (e.g., online games) along with information such as IP addresses, ports, etc. of subscriber devices and servers. The LLD agent 308 may receive information from a subscriber device 302 or an application server indicating initiation of a particular non-queue building application and identify source and destination IP addresses/ports. FIG. 3B illustrates an exemplary upstream traffic flow through a CATV network, in accordance with some embodiments of the present disclosure. The LLD agent 308 resides within a customer premises gateway 304. The gateway 304 may comprise other components such as LLD client 306, but is not limited thereto.

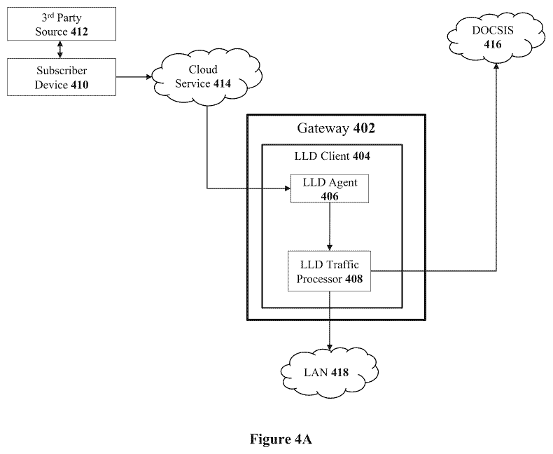

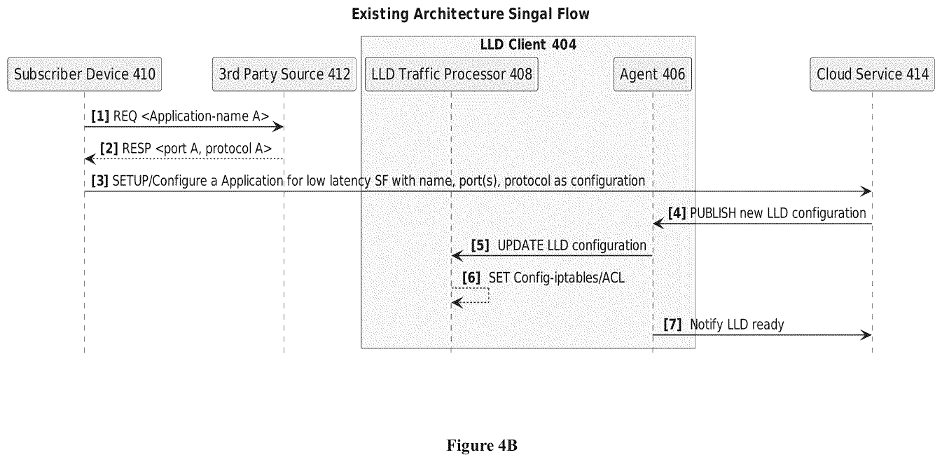

In one exemplary architecture for providing the low latency service flow to the data packets of an application, first the subscriber needs to obtain attributes of the application and thereafter configure/setup the application for the low latency service flow using the attributes. As shown in FIG. 4A, a gateway 402 of the network (i.e., customer premises gateway) comprises a LLD client 404 that decides whether to classify the packets associated with an application as low latency traffic or not, and to pass the packets through either the classic service flow or low latency service flow. The LLD client 404 comprises a LLD agent 406 and LLD traffic processor 408, but not limited thereto. The LLD traffic processor 408 passes only those packets through the low latency service flow, which are associated with the application that is pre-configured as the low latency application.

In order to configure any application or service as the LLD application, the subscriber needs to provide configuration information (i.e., attributes) to the LLD agent 406, which is a manual configuration. The attribute may comprise one or more of: a name of the application, one or more port numbers of the application, a type of protocol of the application, etc., but are not limited to this list. The subscriber device 410 may interact with a third-party source 412 to obtain the attributes for the application that has to be configured as low latency application and provide the attributes of the application to the LLD agent 406 through cloud and internet. The LLD agent 406 may store the attributes of the application in its internal database of the low latency applications. The LLD agent 406 may create rules and policies based on the attributes to forward the packets associated with the application through the LLD service flow. The LLD agent 406 uses the attributes to identify the low latency traffic packets and process that packets in a manner such that the access network can recognize it as such and direct the low-latency packets to the appropriate queues, etc.

The working of the known/existing architecture shown in FIG. 4A may be easily understood by signal flow chart as shown in FIG. 4B. As shown in FIG. 4B, in order to configure the application, the subscriber device 410 may provide application name to the third-party source 412 (shown as step [1] in FIG. 4B). In response, the third-party source 412 may provide other attributes such as the port number and protocol type of the application to the subscriber device 410 (shown as step [2] in FIG. 4B). Thereafter, the subscriber device 410 may communicate with the cloud service 414 to configure the application as low latency application using all the attributes (shown as step [3] in FIG. 4B). The subscriber device 410 may provide configuration information such as application name, port number and protocol type. The cloud service 414 may inform the LLD agent 406 of the new LLD configuration (shown as step [4] in FIG. 4B). Thereafter, the LLD agent 406 may store the attributes such as the application name, the port number and the protocol type of the application in the database. The LLD agent 406 further updates the LLD configuration to the LLD traffic processor 408. The LLD traffic processor 408 may update the Access Control Lists (ACLs) i.e., iptables to route the traffic suitably in the network. After updating the ACL, the LLD agent 406 may confirm that the low latency SF can thereafter be provided to the application.

Those of ordinary skill in the art will appreciate that some attributes of the application such as port number and type of protocol are not static and can change over time. In such cases, the subscriber may need to reconfigure the application as eligible for low latency using the new (updated) attributes of the application, as the previously configured attributes are no longer valid/correct.

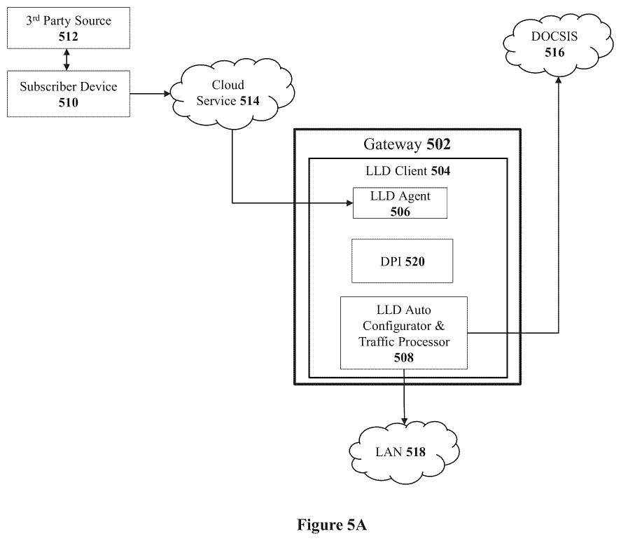

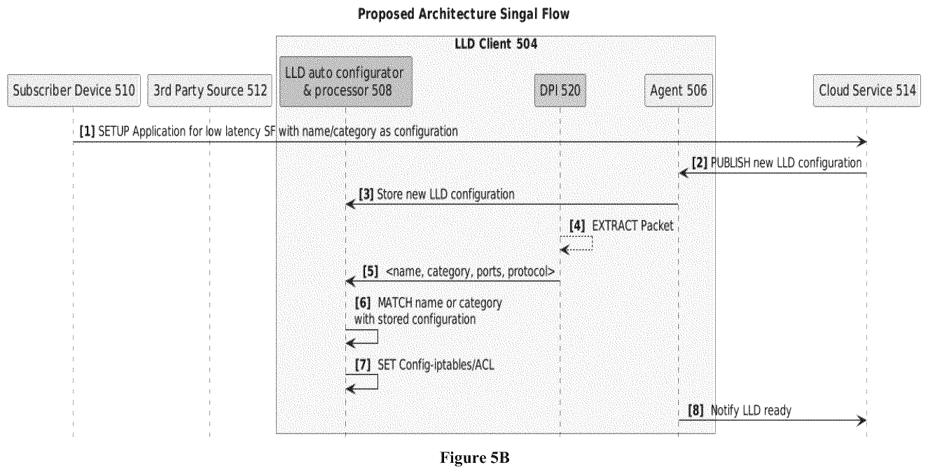

FIGS. 5A and 5B show another implementation that eliminates the need for user-reconfiguration of a low-latency application after a change in its associated attributes, such as port number, type of protocol, etc. Specifically, FIG. 5A, shows an architecture 500 of the network comprising a gateway 502 (i.e., customer premises gateway) for automating the configuration of low latency service with dynamically changing attributes on a customer-managed device (subscriber device 510) in accordance with an embodiment of the present disclosure. As shown in FIG. 5A, the LLD client 504 of the gateway 502 may comprise an LLD agent 506, an LLD auto configurator and traffic processor 508, and a deep packet inspection (DPI) module 520. The LLD agent 506 may be in be operative communication with the one or more edge devices of the network such as CMTS 214, CM 210, a remote physical device (RPD), a remote MACPHY device (RMD), etc, that each propagate data packets onto the communication network. In an embodiment, the gateway 502 may be the same as the gateway shown in FIG. 3B.

In some embodiments, a data packet comprises at least a payload portion and a header portion but is not limited thereto. Attributes of an application stored in either or both of these two portions (or elsewhere in the data packet) may be classified as primary/payload attributes or secondary/additional attributes. The payload attributes may be defined as attributes present in the payload portion of the data packets that are static, such as application category and application name, etc. The additional attributes may be defined as the attributes present in the data packets, and in some embodiments more specifically the header portion, that are dynamic, such as application port number, IP protocol, etc. In an embodiment of the present disclosure, the additional attributes may include but are not limited to one or more of: application IP address, application IP mask, destination IP address, destination IP mask, application IP port start and port end, destination port start and port end, destination MAC address, application MAC address, Ethernet/DSA/MAC type, and virtual LAN identification (VLAN ID.

According to the techniques of the present disclosure, the subscriber or subscriber device 510 need not provide the additional attributes, which are dynamic and can change, to initially configure/set-up the application for a low latency service flow. The subscriber device 510 may only provide the payload/primary attributes that are static when initially configuring the application as the low latency application. In an embodiment, the subscriber device 510 may provide the static attributes such as application category and/or application name for initially configuring the application to cloud service 514 (shown as step [1] in FIG. 5B). The cloud service 514 may inform the LLD agent 506 about the new LLD configuration (shown as step [2] in FIG. 5B). The payload attributes of all applications that are configured as low-latency eligible may be stored in a database of the LLD agent 506 (shown as step [3] in FIG. 5B).

After initial setup/configuration, when a plurality of data packets associated with one or more applications are received at the gateway 502 for routing and transmission in the network towards the destination, the data packets may be analyzed/processed by the LLD client 504 at the gateway 502 for determining the data packets to be associated as low latency service flow (SF) or classic service flow (SF).

According to an embodiment, upon receiving the data packets, the payload portion of each of the data packets may be analyzed to determine the payload attributes of the data packet and to compare the payload attributes with attributes of low latency applications stored in the database. Particularly, the payload attributes of the received data packets are compared with the pre-stored attributes of the applications (which are configured as the low latency applications). If the attributes of any current data packet matches the pre-determined attributes of any low latency application, the current data packet is categorized as a data packet eligible for low-latency service flow. In this manner, based on the analysis (i.e., comparison) of the payload portions of the data packets, a subset of the analyzed data packets are classified as being associated with low-latency service. In an embodiment, the DPI module 520 may extract the payload attributes from the payload portion of the data packets (shown as step [4] in FIG. 5B). Particularly, each of the data packets may be processed using the DPI algorithm to extract the payload attributes.

More particularly, upon extracting the payload attributes from the data packets, the extracted attributes are provided to the auto configurator & traffic processor 508 (shown as step [5] in FIG. 5B). Thereafter, the auto configurator and traffic processor 508 may compare the extracted payload attributes with the pre-determined payload attributes of the low latency applications stored in the database (shown as step [6] in FIG. 5B). For example, considering the payload attribute “name,” the name of the application is extracted from the data packets and the auto configurator and traffic processor 508 may check whether the extracted name matches any of the predetermined names of applications configured as the low latency applications. By this comparison, the auto configurator and traffic processor 508 may determine whether or not the extracted the payload attribute of the application matches the predetermined attributes of the at least one predetermined low latency application. As described earlier, an application may be predetermined as low-latency eligible using the payload attributes such as name and/or category of the application. The LLD client 504 may store the attributes of the applications that are pre-configured as low-latency applications. In this manner, it may be determined whether or not the data packets are associated with a low-latency application based on a result of the comparison. Therefore, a subset of the analyzed data packets may be classified as being eligible for low-latency service.

After the classification of the subset of the analyzed packets, the header portion of the subset of data packets may be processed to determine the header characteristics i.e., additional attributes. The determined additional attributes may be stored in the database. Upon identification of the application as low-latency eligible, the auto configurator and traffic processor 508 may automatically configure the application to provide low latency service flow using the additional attributes. In this manner, the auto configurator and traffic processor 508 may pass a data packet of an application either through low-latency service flow or the classic service flow based on the identification. The extracted additional attributes may be transmitted to the edge device which may be a Cable Modem Termination Service (CMTS), a Remote Physical Device (RPD), a Remote MACPHY Device (RMD) and cable modem (CM) of the communication network for identification of the low latency traffic in the communication network.

Further, the LLD client 504 may use the extracted payload and additional attributes to set the policies for identifying the data packets that should be marked for the low-latency service flow, and thereby enabling the network to correctly route such packets in the low-latency service flow as defined by the DOCSIS standard. The LLD client 504 preferably uses the port numbers and protocol information of the packets to identify low latency traffic and process that traffic in a manner such that the network can recognize it as such and direct the low-latency traffic to the appropriate queues. The LLD client 504 may set the policies to divert low latency traffic using Access Control Lists (ACLs) (shown as step [7] in FIG. 5B). These ACL lists (routing entries) may be injected into routers of the network using a control channel or using dynamic routing protocols. According to an embodiment, instead of updating the ACL every time for each packet, the auto LLD client 504 may choose to skip the ACL update process until there is any change in the attributes extracted from previous packets of same application (i.e., until there is change in the port number or protocol type of the application). After updating the ACL, the LLD agent 506 may confirm that the low latency SF may be provided to the data packets (shown as step [8] in FIG. 5B).

In an embodiment, the communication network may use the additional attributes of the data packets to classify upcoming/additional data packets as being associated with low latency service. Particularly, upon receiving the upcoming/additional data packets (different from the plurality of data packets earlier received), based on the additional attributes, the additional data packets may be classified as being eligible for low latency service over the communications network.

In this manner, the techniques of the present disclosure dynamically automates the configuration of the low latency services with their dynamically changing attributes on the subscriber managed devices, thereby eliminating the need for subscriber to manually add/update the attributes of such services each time.

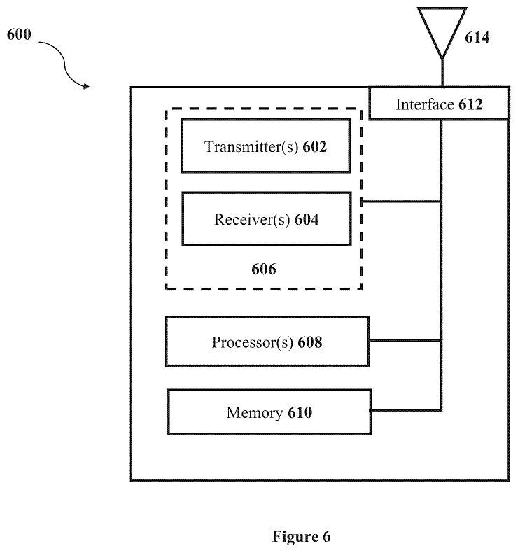

FIG. 6 shows a high-level block diagram of an apparatus 600 for provisioning low-latency service flow for data packets associated with an application in a communication network conforming to Data Over Cable Service Interface Specification (DOCSIS) standard, in accordance with some embodiments of the present disclosure. The apparatus 600 may comprise at least one transmitter 602, at least one receiver 604, at least one processor 608, at least one memory 610, at least one interface 612, and at least one antenna 614. The at least one transmitter 602 may be configured to transmit data/information to one or more external nodes/devices using the antenna 614 and the at least one receiver 604 may be configured to receive data/information from the one or more external nodes/devices using the antenna 614. The at least one transmitter and receiver may be collectively implemented as a single transceiver module 606. In one non-limiting embodiment, the at least one processor 608 may be communicatively coupled with the transceiver 606, memory 610, interface 612, and antenna 614 for implementing the above-described techniques.

The at least one processor 608 may include, but not restricted to, microprocessors, microcomputers, micro-controllers, central processing units, state machines, logic circuitries, and/or any devices that manipulate signals based on operational instructions. A processor may also be implemented as a combination of computing devices, e.g., a combination of a plurality of microprocessors or any other such configuration. The at least one memory 610 may be communicatively coupled to the at least one processor 608 and may comprise various instructions, a list of low-latency applications, subscriber information, information related to one or more downstream and upstream packet classifiers, information related to network ports used by the low-latency applications, information related to topology of the CATV network, etc. The at least one memory 610 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 608 may be configured to execute one or more instructions stored in the memory 610.

The interfaces 612 may include a variety of software and hardware interfaces, for example, a web interface, a graphical user interface, an input device-output device (I/O) interface, a network interface and the like. The I/O interfaces may allow the apparatus 600 to communicate with one or more external nodes/devices either directly or through other devices. The network interface may allow the apparatus 600 to interact with one or more networks either directly or via any other network(s). In one non-limiting embodiment, the apparatus 600 may be a part of the LLD agent or the LLD client comprising the LLD agent and traffic processor, but not limited thereto.

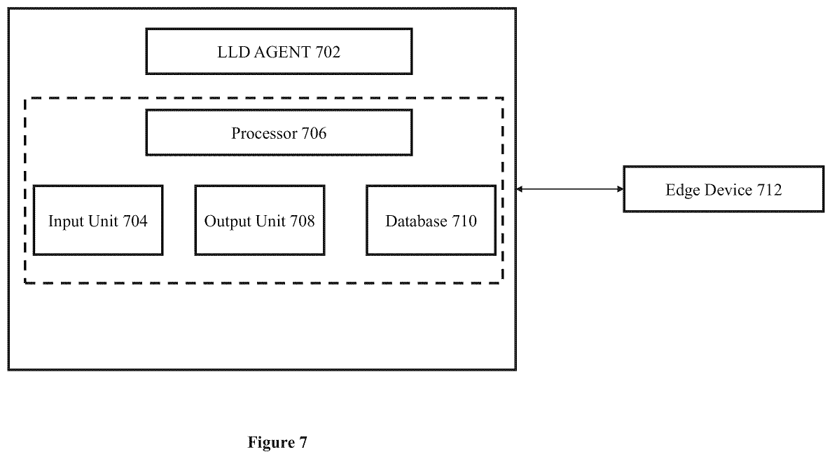

FIG. 7, illustrates a block diagram of a low latency DOCSIS (LLD) agent, in accordance with some embodiments of the present disclosure. The LLD agent 702 may be in operative communication with at least one edge device 712 that propagates the signal or data packets onto the network. Although only one edge device is shown in FIG. 7, it should not be construed as limiting and there may be more than one edge device in communication with the LLD agent 702. The LLD agent may same as the LLD agent shown in FIGS. 3B, 5A and 5B. The LLD agent 702 may comprise an input unit 704, at least one processor 706, an output unit 708, and a database 710, but not limited thereto.

In an embodiment, the input 704 may receive a first plurality of data packets that are eligible for low-latency service over the communication network. Each of the data packets comprises at least a header portion and a payload portion. The payload portion may comprise payload attributes, which may comprise at least one of: an application name and an application category. In an embodiment, the payload portion comprises the static attributes of the application, where the header portion comprises the dynamic attributes of the application. The dynamic attributes may also be referred to as additional attributes, which may change over time for an application. The additional/dynamic attributes are part of the header portion and may also be referred to as header characteristics. The header characteristics/additional attributes may be one or more of: an application port number, an IP protocol, an application IP address, an application IP mask, a destination IP address, a destination IP mask, an application IP port start and port end, a destination port start and port end, a destination MAC address, an application MAC address, an Ethernet/DSA/MAC type, and a virtual LAN identification (VLAN ID).

Upon receiving the data packets, the processor 706 may analyze the payload attributes of the data packets i.e., may compare the payload attributes of the data packets with predetermined attributes/characteristics of low latency application stored in a database 710. In an embodiment, the attributes of applications, which require low-latency service, may be pre-stored in the database 710. The predetermined attributes/characteristics may comprise at least one of an application category and an application name. Thus, upon receiving the data packets, the payload characteristics of the data packets may be compared with the pre-stored attributes to determine whether the data packets are associated with an application which is eligible for or require the low latency service. Based on the analysis (comparison) of the payload of the data packets, the processor 706 may identify the characteristics of the header portion of the data packets.

After identifying the header characteristics, the header characteristics may be provided to the edge device 710 by the output unit 708. The edge device 710 may use the header characteristics to identify a second plurality of data packets among the upcoming data packets which are also eligible for low-latency service over the communication network. The processor 706 may provide the low-latency services to the one or more packets of the upcoming data packets by examining the header characteristics of the upcoming data packets. In an embodiment, the LLD agent 702 may configured by a cloud agent to modify the payload attributes. In this manner, the LLD agent 702 of the present disclosure may automatically provision the low latency service flow for the data packets even with the dynamically changing attributes on the subscriber managed devices.

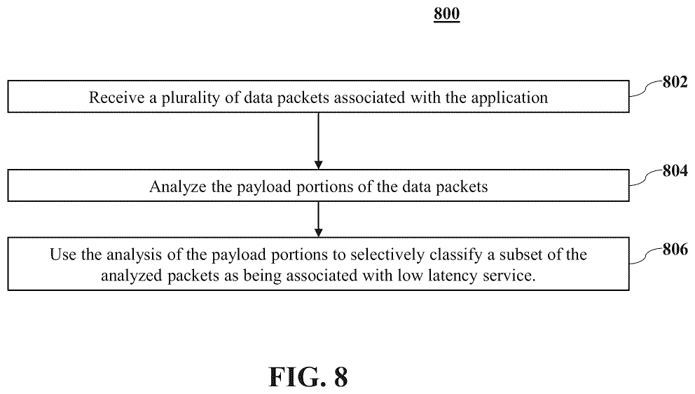

FIG. 8 shows a flowchart illustrating a method 800 provisioning low-latency service flow for data packets associated with an application in a communication network conforming to the Data Over Cable Service Interface Specification (DOCSIS) standard, in accordance with some embodiments of the present disclosure. The various operations of the method 800 may be performed with the help of the apparatus 600 or the LLD client 504 or LLD agent 702.

As illustrated in FIG. 8, the method 800 may include, at a block 802, receiving a plurality of data packets associated with the application. Each of the plurality of data packets comprises at least a header portion and a payload portion. When data packets are generated and transmitted by one or more applications, the data packets are received by the gateway 502 for routing and transmission of the data packets in the network towards destination. According to the present disclosure, the data packets may be processed to determine whether to pass the data packet through either the low latency service flow or the classic service flow. In an embodiment, the payload portion comprises payload attributes, which may be at least one of: an application name and an application category. The payload portion comprises the static attributes of the application, where the header portion comprises the dynamic attributes of the application. The dynamic attributes may also be referred to as additional attributes, which may change over time for an application. The additional/dynamic attributes are part of the header portion, and may also be referred to as header characteristics. The header characteristics/additional attributes may be one or more: an application port number, an IP protocol, an application IP address, an application IP mask, a destination IP address, a destination IP mask, an application IP port start and port end, a destination port start and port end, a destination MAC address, an application MAC address, an Ethernet/DSA/MAC type, and a virtual LAN identification (VLAN ID.

The method 800 may also include, at block 804, analyzing the payload portions of the data packets. According to an embodiment, the each of the data packets may be analyzed by the DPI module 520 to extract the payload attributes of the application. Particularly, the data packets may be processed using the DPI algorithm to extract the payload attributes of the application. After extracting the payload attributes, the payload attributes are compared with predetermined attributes of low latency applications.

In an embodiment, the payload attributes of the received data packets are compared with the pre-stored attributes of the applications (which are configured as the low-latency applications). If the attributes of any data packet matches the pre-determined attributes of any low latency application, the data packet is categorized as a data packet eligible for the low latency service flow. In this manner, based on the analysis (i.e., comparison) of the payload portions of the data packets, a subset of the analyzed data packets are classified as being associated with low-latency service. Thus, the method 800, at block 806, recites using the analysis of the payload portions to selectively classify a subset of the analyzed packets as being associated with low-latency service. The method 800 further comprises using the classification of the subset of the analyzed packets to determine a set of additional attributes in the analyzed data packets and using the additional attributes to classify additional data packets as being associated with low-latency service. In an embodiment, the additional attributes are in a header of the analyzed packets, and the additional data packets are associated with low latency service by examining the header of the additional data packets. In an embodiment, the additional attributes are selected from a group comprising one or more of: an application port number, an IP protocol, an application IP address, an application IP mask, a destination IP address, a destination IP mask, an application IP port start and port end, a destination port start and port end, a destination MAC address, an application MAC address, an Ethernet/DSA/MAC type, and a virtual LAN identification (VLAN ID).

According to an embodiment, provisioning the low latency service flow for the data packet based on the additional attributes comprises updating Access Control Lists (ACLs) of the communication network using the additional attributes. For example, the auto configurator module 522 may update Access Control Lists (ACLs) of the communication network using the secondary attribute(s) in order to provision the low-latency service flow for the data packet associated with the low-latency application. Further, the extracted additional may be transmitted to a cable modem (CM) of the communication network for identification of the low-latency traffic in the communication network.

In one non-limiting embodiment, the method 800 recites use of the payload and additional attributes to set the policies for identifying the data packets that should be marked for the low-latency service flow, and thereby enabling the network to correctly route such packets in the low-latency service flow as defined by the DOCSIS standard. The port numbers and protocol information of the packets are used to identify low latency traffic and process that traffic in a manner such that the network can recognize it as such and direct the low-latency traffic to the appropriate queues. Further, the policies to divert low latency traffic may be created using Access Control Lists (ACLs). These ACL lists (routing entries) may be injected into routers of the network using a control channel or using dynamic routing protocols.

In this manner, the techniques of the present disclosure dynamically automates the configuration of the low latency services with their dynamically changing attributes on the subscriber managed devices, thereby eliminating the need for subscriber to manually add/update the attributes of such services each time.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. Generally, where there are operations illustrated in Figures, those operations may have corresponding counterpart means-plus-function components. It may be noted here that the subject matter of some or all embodiments described with reference to FIGS. 1-8 may be relevant for the method and apparatus and the same is not repeated for the sake of brevity.

In a non-limiting embodiment of the present disclosure, one or more non-transitory computer-readable media may be utilized for implementing the embodiments consistent with the present disclosure. A computer-readable media refers to any type of physical memory (such as the memory 610) on which information or data readable by a processor may be stored. Thus, a computer-readable media may store one or more instructions for execution by the at least one processor 608, including instructions for causing the at least one processor 608 to perform steps or stages consistent with the embodiments described herein. Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The various illustrative logical blocks, modules, and operations described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise. The terms “including”, “comprising”, “having” and variations thereof, when used in a claim, is used in a non-exclusive sense that is not intended to exclude the presence of other elements or steps in a claimed structure or method, unless expressly specified otherwise.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the invention, which is set forth in the appended claims.

1. A method of provisioning low-latency service flow for data packets associated with an application in a communication network conforming to Data Over Cable Service Interface Specification (DOCSIS) standard, the method comprising:
receiving a plurality of data packets associated with the application, each data packet including a payload portion;
analyzing the payload portion of the data packets; and
using the analysis of the payload portion of the data packets to selectively classify a subset of the analyzed data packets as being associated with low latency service.

2. The method of claim 1, where the analysis of the payload portions comprises comparing payload attributes of the payload portions to predetermined attributes of low latency applications.

3. The method of claim 2, where the payload attributes are selected from a group comprising: an application category and an application name.

4. The method of claim 1, further including the steps of:
using the classification of the subset of the analyzed data packets to determine a set of additional attributes in the analyzed data packets; and
using the additional attributes to classify additional data packets as being associated with low latency service.

5. The method of claim 4, where the additional attributes are in a header of the analyzed data packets, and the additional data packets are associated with low latency service by examining the header of the additional data packets.

6. The method of claim 4, wherein the additional attributes are selected from a group comprising one or more of: an application port number, an IP protocol, an application IP address, an application IP mask, a destination IP address, a destination IP mask, an application IP port start and port end, a destination port start and port end, a destination MAC address, an application MAC address, an Ethernet/DSA/MAC type, and a virtual LAN identification (VLAN ID).

7. The method of claim 1, wherein provisioning the low latency service flow for data packets based on additional attributes comprises at least one of:
updating Access Control Lists (ACLs) of the communication network using the additional attributes; and
transmitting the additional attributes to a cable modem (CM) of the communication network for identification of low latency traffic in the communication network.

8. An apparatus for provisioning low-latency service flow for data packets associated with an application in a communication network conforming to Data Over Cable Service Interface Specification (DOCSIS) standard, the apparatus comprising:
a memory; and
processors communicatively coupled with the memory and configured to:
receive a plurality of data packets associated with the application, each data packet including a payload portion;
analyze the payload portion of the data packets; and
use the analysis of the payload portion of the data packets to selectively classify a subset of the analyzed data packets as being associated with low latency service.

9. The apparatus of claim 8, wherein the processors are configured to analyze the payload portions by comparing payload attributes of the payload portions to predetermined attributes of low latency applications.

10. The apparatus of claim 8, wherein the payload attributes are selected from a group comprising: an application category and an application name.

11. The apparatus of claim 8, further the processors are configured to:
use the classification of the subset of the analyzed data packets to determine a set of additional attributes in the analyzed data packets; and
use the additional attributes to classify additional data packets as being associated with low latency service.

12. The apparatus of claim 11, where the additional attributes are in a header of the analyzed data packets, and the additional data packets are associated with low latency service by examining the header of the additional data packets.

13. The apparatus of claim 8, wherein the additional attributes are selected from a group comprising: an application port number, an IP protocol, an application IP address, an application IP mask, a destination IP address, a destination IP mask, an application IP port start and port end, a destination port start and port end, a destination MAC address, an application MAC address, an Ethernet/DSA/MAC type, and a virtual LAN identification (VLAN ID).

14. The apparatus of claim 8, wherein to provision the low latency service flow for data packets based on the additional attributes, processors are configured to:
update Access Control Lists (ACLs) of the communication network using secondary attributes; and
transmit the additional attributes to a cable modem (CM) of the communication network for identification of low latency traffic in the communication network.

15. A low-latency DOCSIS (LLD) agent in operative communication with at least one edge device that propagates a signal onto a communications network, the LLD agent comprising:
an input that receives a first plurality of data packets eligible for low latency service over the communications network, each having a header and a payload;
a processor that analyses the payload of the data packets and uses the analysis to identify header characteristics of the header of the first plurality of data packets; and
an output that provides the edge device with the header characteristics, the header characteristics usable by the edge device to identify a second plurality of data packets, different from the first plurality of data packets, also eligible for low latency service over the communications network.

16. The LLD agent of claim 15, where the analysis of the payload portions comprises comparing payload attributes of the payload portions to predetermined characteristics of low latency applications.

17. The LLD agent of claim 16 configurable by a cloud agent to modify the payload attributes.

18. The LLD agent of claim 16, where the predetermined characteristics comprise at least one of an application category and an application name.

19. The LLD agent of claim 15, where the header characteristics are selected from a group comprising: an application port number, an IP protocol, an application IP address, an application IP mask, a destination IP address, a destination IP mask, an application IP port start and port end, a destination port start and port end, a destination MAC address, an application MAC address, an Ethernet/DSA/MAC type, and a virtual LAN identification (VLAN ID).

20. The LLD agent of claim 15, where the at least one edge device is at least one of a Cable Modem Termination Service (CMTS), a Remote Physical Device (RPD), a Remote MACPHY Device (RMD) and a cable modem.
